(19) United States
(12) Patent Application Publication
(10) Pub. No.: US 2005/0066353 A1
(43) Pub. Date: Mar. 24, 2005

(54) Method and system to monitor delivery of content to a content destination

(76) Inventor: Robert Fransdonk, Vista, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/665,333

(22) Filed: Sep. 18, 2003

(51) Int. Cl. H04N 7/16

(52) U.S. Cl. 725/29; 725/25

(57) ABSTRACT

A media delivery network is provided which includes a digital rights server and a media server to store content to deliver to a content consumer upon demand. The digital rights server stores content consumer rights defining access rights of a content consumer with respect to content, and content owner rights defining access policies to the content as established by a content owner. In one embodiment, the delivery of the content to the content consumer is timed and the access rights of the content consumer are updated in response to a delivered time during which the content was delivered to the content consumer. The invention extends to a method of controlling the delivery of content from a media server to a content destination or consumer and to a machine-readable medium for storing a set of instructions to execute any one or more methods of the invention. In one embodiment, further delivery may be denied after a certain position within the media has been reached.

### FIELD OF THE INVENTION

The present invention relates generally to the field of network communications and, more specifically, to methods and systems for the distribution and delivery of content via a communications network.

### BACKGROUND OF THE INVENTION

The proliferation of networks, and the widespread acceptance of the Internet as a communication and distribution channel in particular, have presented a number of opportunities for pay media content distribution. Specifically, broadband Internet Protocol (IP) networking has provided a number of new opportunities for publishing and media content distribution worldwide. The ability of networks to support resource-intensive media, such as streaming media multicasting, is growing rapidly as broadband IP technologies allow content and service providers to distribute high-quality video to millions of subscribers simultaneously.

However, these opportunities have been accompanied by concerns regarding content piracy and digital rights management (DRM). A challenge facing traditional pay media distributors is to enable content providers to control their proprietary content, while maintaining the flexibility to distribute media content widely. The increased distribution potential heightens the need to protect and secure media content. For example, a content provider may have particular concerns regarding preventative measures to minimize the possibility of premium content falling into wrong hands, and the enforcement of copyrights.

### SUMMARY OF THE INVENTION

According to one aspect of the present invention,

According to the invention, there is provided a media delivery network, which includes:
a media server to store content to deliver to a content consumer upon demand; and
a digital rights server to store content consumer rights defining access rights of a content consumer with respect to content, and content owner rights defining access policies to the content as established by a content owner,
wherein the delivery of the content to the content consumer is timed and the access rights of the content consumer are updated in response to a delivered time during which the content was delivered to the content consumer.

The invention extends to a method of controlling the delivery of content from a media server to a media player/client. Further, the invention also extends to a machine-readable medium for executing a set out of instructions to carry out any of the methodologies described herein.

Other features of the present invention will be apparent from the accompanying drawings and from the detailed description that follows.

### BRIEF DESCRIPTION OF THE DRAWINGS

The present invention is illustrated by way of example, and not limitation, in the figures of the accompanying drawings, in which like references indicate similar elements and in which:

FIG. 1 is a block diagram illustrating details regarding software components that may reside at various locations of a content distribution system to facilitate distribution and delivery processes.

FIG. 2 is a block diagram illustrating further architectural details regarding an exemplary embodiment of a content distribution system.

FIG. 3 is a diagrammatic representation of an exemplary deployment of the digital rights network, according to one embodiment of the present invention, and illustrates the interactions of a content provider, a content distributor, a commerce service provider and a content destination with the components of the digital rights network.

FIG. 4 is a flowchart illustrating a method, according to an exemplary embodiment of the present invention, of obtaining session data during a content ordering operation.

FIG. 5 is a flowchart illustrating a method, according to an exemplary embodiment of the present invention, of requesting and delivering content to a content destination/consumer.

FIG. 6 is a flowchart illustrating a method, according to an exemplary embodiment of the present invention, of monitoring the delivery of content by a media server to the content consumer.

FIG. 7 is a schematic illustration showing communications in a digital rights network, in accordance with one embodiment of the invention.

FIG. 8 is a block diagram illustrating a machine, in an exemplary form of a computer system, which may operate to execute a sequence of instructions, stored on a machine-readable medium, for causing the machine to perform any of the methodologies discussed in the present specification.

### DETAILED DESCRIPTION

A media delivery network, and methods of operating and implementing the same, is described. In the following description, for purposes of explanation, numerous specific details are set forth in order to provide a thorough understanding of the present invention. It will be evident, however, to one skilled in the art that the present invention may be practiced without these specific details and that these specific details are exemplary.

Overview—Content Distribution System

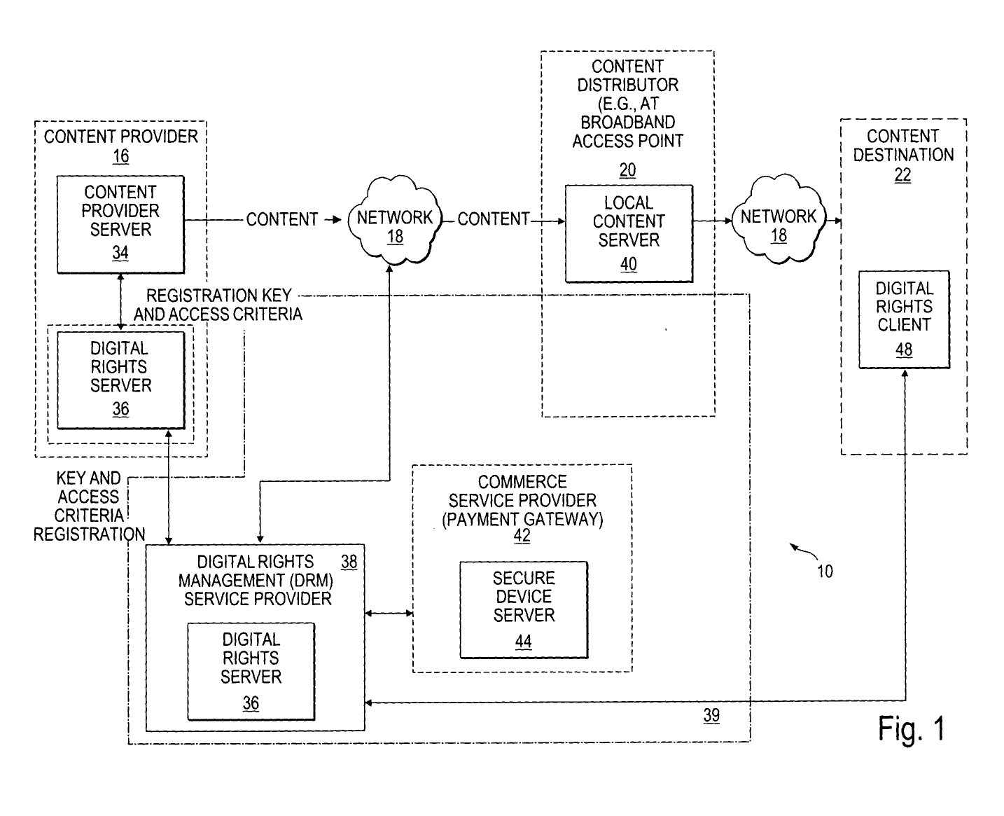

FIG. 1 is a block diagram showing details regarding software components that may, in one exemplary embodiment, reside at the various locations of a content distribution system to facilitate distribution and delivery processes. A content provider 16 operates a content provider server 34 that is responsible for the actual distribution of content from the content provider 16. For example, the content provider server 34 may comprise a streaming media server (e.g., the Real Networks streaming media server developed by Real Networks of Seattle, Wash. State or a Microsoft media server developed by Microsoft of Redmond, Wash. State). A digital rights server 36 (e.g., the Entriq Server developed and distributed by Entriq of Carlsbad, Calif.) is optionally included to define and store access rights to content of the content provider 16, to perform digital rights management, to encrypt content, and to manage and distributed product keys. To this end, the content provider server 34 and the digital rights server 36 are shown to communicate registration keys and access criteria.

While the digital rights server 36 is shown to reside with a content provider 16, in an alternative embodiment, a digital rights server 36 may reside at a digital rights service provider (ASP) 38. In this case, the digital rights server 36 may perform the above-described functions for multiple content providers 16. In one embodiment, a collection of the digital rights servers 36 may operate as a nucleus of a digital rights network 39.

An exemplary content distributor 20 is shown to host a local content server 40 and, optionally, a digital rights agent. Alternatively, the digital rights agent may be located remotely from the content distributor 20, and accessed by the content distributor 20 via the network 18. The local content server 40 may again be a streaming media server that streams cached (or freshly received) media. If a content destination 22 is authorized and/or payment is cleared, requested content might optionally be decrypted, personally watermarked, personally re-encrypted and delivered to the content destination 22.

To review, the content distribution system may be implemented by a distributed collection of digital rights servers 36, and digital rights clients 48 that operate in conjunction with media servers and viewing devices (e.g., players) to protected the rights of a content provider 16 in specific content, while facilitating the widespread distribution of content. A digital rights server 36 enables the content provider 16 to encrypt and associate access criteria (e.g., pay-per-view, pay-per-time, subscription) with content. The digital rights server 36 also manages subscriptions and provides monitoring and statistic tools to a content provider 16. A digital rights client 48 is located at a destination device (e.g., the PC, a STB, and mobile phone, game console or the like) and manages an interface between a secure device 46 and a subscriber.

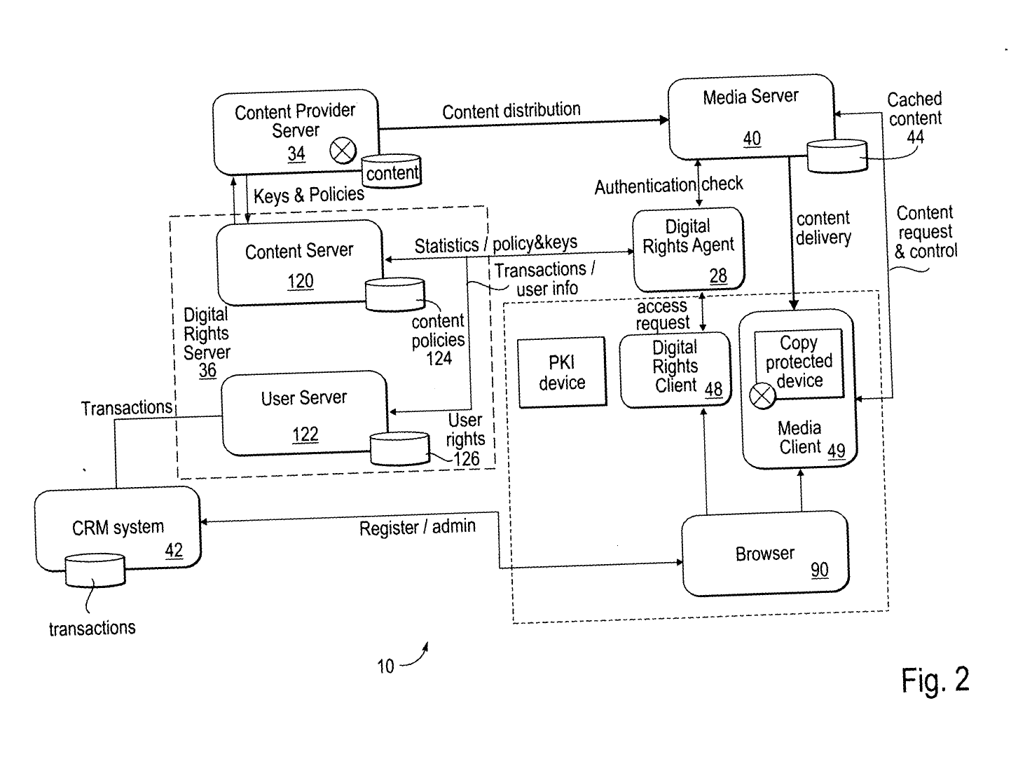

FIG. 2 is a block diagram showing architectural details regarding an exemplary embodiment of a content distribution system 10. The functioning of the various components of the content distribution system 10, as shown in FIG. 2, will now be the described in the context of registration, content ordering and transaction processing operations.

The content distribution system 10 consists of a number of sub-systems that together provide a required functionality. In one embodiment, these sub-systems seek to enable the Internet infrastructure to be utilized as a safe and secure medium for online selling and buying of content, data, programs, products and services context, including video and audio encoders, servers, players, clearing systems and existing Websites.

The content distribution system 10, in one embodiment, seeks to provide at least the following functions:
(1) Conditional access to management through various access criteria schemes.
(2) End-to-end content security and copy protection, using encryption and watermarking technology.
(3) Transaction and purse management, using Public Key Infrastructure (PKI) and extensible Markup Language (XML) technology.
(4) Pay-per-view, pay-per-time and subscription based access.
(5) Access control on the basis of region and date/time.
(6) Varying prices on the basis of region and date/time.
(7) Management of a variety of (debit and credit) purses.
(8) Scaling to many (simultaneous) subscribers using a highly distributed architecture.
(9) Secure device portability, using the standard PKCS#11 interface.
(10) User platform portability by defining an interface based on HTT and XML, allowing a range of subscriber platforms (PC/STB/GSM).

The above listed functions, in one embodiment, are enabled primarily by the following components:
(1) Digital rights clients 48 are located at content destinations 22 to sign content transactions and manage the content decryption process. The digital rights clients 48 may each operate in conjunction with a secure device 46 (e.g., an e-Token or smart card).
(2) Digital rights servers 36, within a digital rights network 39, that are accessible by content providers 16 (e.g., via DRM service providers 38). In the digital rights service provider embodiment, a content provider 16 may access a website operated by a digital rights management (DRM) service provider 38 to secure content and to define access conditions (e.g., pay per view, subscription, etc) associated with the content. As illustrated in FIG. 2, a digital rights server 36 includes a content server 56 and a user server 58. The content server 56 hosts (e.g., stores and facilitates retrieval of) registered content items, and content rights (or content owner rights) 60, for a number of content providers 16. The user server 58 hosts (e.g., stores and facilitates retrieval of) registered users (or content consumers), and associated user (or content consumer) rights 62, for a number of users.
(3) Digital rights agents 28 may be located at various points within the digital rights network 39 to act as “brokers” enforcing the business rules and security settings that are associated with content by content providers 16. Digital rights agents 28 also include encryption capabilities to enable the performance of cryptographic operations with respect to access operations relating to one more digital rights servers 36 (e.g., access operations to user rights 62 stored by a user server 58 and access operations to content rights 60 stored by a content server 56). The digital rights agents 28 also include watermarking capabilities to increase the level of security “at the last mile”.
User servers 58 may be access by commerce service providers 42 (e.g., pay-media or Customer Relationship Management (CRM) operators) or payment gateways to manage secure devices and associated purses in the field.

FIG. 2 illustrates the interactions and communications between the above-mentioned components of the digital rights network 39. The components of the digital rights network 39 are also shown to interface with various third party components and systems. The user server 58 interfaces with a commerce service provider 42 in the form of external CRM system to forward transactions and user events. The content aggregator or an Internet Service Provider (ISP) typically hosts the CRM system. The value of the transaction is settled with the various parties (content owner/provider, network provider/ISP, clearing house, etc). The digital rights network 39 allows external systems to register and un-register users, and control debit, credit, subscriptions and other user rights.

The digital rights client 48 may interface with a PKI device 54 at the subscriber PC or other media device. Example PKI devices are software certificates, hardware smart cards or e-Tokens. The digital rights network 39 supports both the PKCS#11 as well as the Microsoft CSP interface to remain device independent. The digital rights client 48 also interfaces device with non-PC client platforms such as Set Top Boxes, PDA's and mobile telephones enabled with (smart card) PKI technology.

The streaming media server 40 notifies the digital rights agent 28 when a user starts and stops the streaming process for security and tracking purposes utilizing plug-ins for various streaming media technologies (Microsoft, Real, MPEG-4) and platforms (Windows, UNIX).

Further details regarding the functions and architecture of the components of the digital rights network 39, according to one exemplary embodiment of the present invention, are now discussed.

Overview—Digital Rights Network

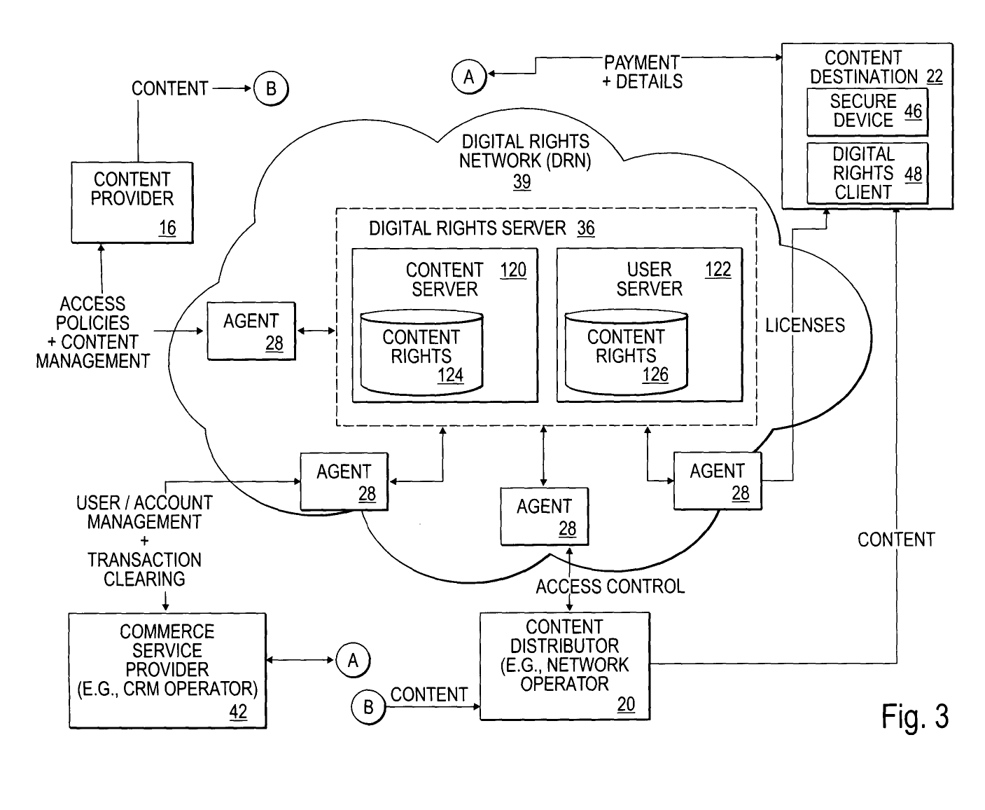

FIG. 3 is a diagrammatic representation of an exemplary deployment of the digital rights network 39, according to one embodiment of the present invention, and illustrates the interactions of a content provider 16, a content distributor 20, a commerce service provider 42 and a content destination 22 with the above-described components of the digital rights network 39. As illustrated in FIG. 3, the digital rights agents 28 are the main entry points (or gateways) into the digital rights network 39 via which access operations with respect to the content rights 60 and user rights 62 are performed. To this end, most cryptographic operations (e.g., user authentication, license creation, data decryption, signing and signature verification) are handled by a distributed collection of digital rights agents 28, with “data” referring to data stored in the digital rights network 39 including content keys, content access policies and user rights.

From the perspective presented in FIG. 3, it will be appreciated that all entities outside the digital rights network 39 may be regarded as “users” of the digital rights network 39. In one embodiment, each such a “user” has one or more certificates that are utilized to authenticate the user to a digital rights agent 28. In the situation where the user is a content consumer (e.g., a subscriber), a certificate may be bound to certain user rights 62 that the user may have acquired through, for example, a content distributor 20 (e.g., a network operator). A user may furthermore have multiple certificates, each certificate being for a one of multiple devices at one or more content destinations 22, such as a PC at home, a PC at work and a PDA for travel. The digital rights network 39 manages the logical links between certificates and user rights, as indicated by the CRM operator. Alternatively, users may also be authenticated using a username and password combination.

The digital rights network 39 operates to facilitate access operations (e.g., registration, storage, retrieval and verification) with respect to the content and user rights 60 and 62. Certain users of the network 39 require rights to access content (e.g., the content consumer), to register content and content keys (e.g., the content provider 16), to update content rights (e.g., the content provider 16), and to register and update user rights (e.g., the commerce service provider 42 or the content distributor 20). The digital rights network 39, as illustrated in FIG. 3, seeks to facilitate the access operations with respect to such rights, and to enable the management of such rights.

While FIG. 3 illustrates a single digital rights server 36, the digital rights network 39 may include a distributed set of digital rights servers 36 that are utilized to host the content and user rights 60 and 62. Such servers 36 may be located at strategic locations on the digital rights network 39. All queries, updates, registrations and exercises of rights (e.g., content or user rights 60 or 62) take place by issuing appropriate requests from a “user” to a digital rights agent 28. For example, where a content provider 16 performs an access operation with respect to the content rights 60 to register content and submit an appropriate content key into the network 39, the digital rights agent 28 verifies that the content provider 16 (as a network “user”) has the rights to register content. Where a commerce service provider 42 (e.g., a content aggregator or CRM operator) performs an access operation to bind content to a specific policy, the digital rights agent 28 verifies whether the commerce service provider 42 has the rights to bind the relevant content items to the relevant policy. Where a content distributor 20 (e.g., a network operator) performs an access operation to modify the user rights of a specific content consumer, the digital rights agent 28 operates to verify that the content distributor 20 has the rights to update the relevant user rights. As such, the user rights 62, in one embodiment of the present invention, may record the rights of all “users” of the digital rights network 39 to perform access operations with respect to the network 39. For example, the user rights 62 may include records of: (1) the rights of the content provider 16 to register content, register access policies relating to the content, to register keys for the content, and to perform management of the content; (2) the rights of commerce service providers 42 to establish and manage user (or account) rights for content consumers; (3) the rights of content distributor 20, with which a content consumer may have relationship, to change the user rights of a content consumer (e.g., where the content consumer subscribes to new content); and (4) the rights of a content consumer (e.g., a subscriber) to access certain content via a device as a content destination 22.

In one embodiment, all users of the digital rights network 39 are authenticated with standard X.509 certificates and the Secure Socket Layer (SSL) transport protocol (client and service authentication). Depending on the content access policy configuration, users of the network 39 may also be allowed to authenticate themselves using a user name and password.

Between a user and a digital rights agent 28, data may be protected utilizing transport layer SSL. Within the digital rights agent 28, content keys and access policies 60 and user rights 62 are encrypted and signed before they are stored within the network 39 at one or more digital rights servers 36. In this way, unauthorized access by an administrator of the network 39 (or by a hacker) is combated.

A digital rights agent 28 also operates to create licenses for distribution to a content destination 22 so as to allow a content consumer to access specific content. Licenses for content may be created within the digital rights agent 28 utilizing a variety of license formats, based on the relevant user secure media player 46. In some cases, content may be delivered in the clear, but access to the content limited through a simple access control (i.e., content is not delivered from a content distributor 20 until user rights of a content consumer to access the content have been cleared).

Referring specifically to FIG. 3, a content provider 16 is shown to access the digital rights network 39, via a digital rights agent 28, to store access policies with respect to content within the network 39, and to perform content management. In one embodiment, an access policy describes conditions under which access to content (e.g., audio, video or data) is provided to a content consumer. Access policies (or content policies) including access criteria are defined by the content provider 16 and are associated with registered content, the content typically being encrypted with a key, as described above. Examples of policies include payments policies (e.g., pay-per-view, pay per time), geographical constraint policies, time constraint policies and subscription policies). A policy may specify rules and conditions (or criteria) governing access to content (e.g., subscription, payments, age or region criteria). Content management that may be performed by the content provider 16 includes encoding, encrypting, indexing, archiving and delivery of content. Encryption keys are registered with the digital rights network 39 and associated with the appropriate content item and access policies. The content provider 16 is also illustrated to distribute content to a content distributor 20 for caching and/or delivery to a content consumer.

FIG. 3 illustrates a commerce service provider 42 (e.g., a CRM operator) as performing user (or account) management and transaction clearing access operations relating to the digital rights network 39 via a digital rights agent 28. Where the commerce service provider 42 comprises a CRM operator, performing customer care, billing and invoicing, clearing, settlement and data warehousing functions. The CRM operator may access the digital rights network 39 to post and retrieve user rights. Such functions may be performed with respect to accounts maintained within the digital rights network 39. Multiple users may share a single account (e.g., employees of the company or members of a family) and account may be an entity financially responsible for a number of users. The commerce service provider 42 is also shown to be in communication with a secure device 46 at a content destination 22 for the purposes of receiving payment (and other details) pertaining to a user (or account). Specifically, a content consumer, via a secure device 46, may authorized a payment for certain subscription rights to specific content, the details of this payment being communicated to the commerce service provider 42. The commerce service provider 42 may then update an account within the digital rights network 39 to reflect the payment.

A content distributor 20 (e.g., a network operator) is illustrated to perform access control (e.g., to query user rights 62 of a content consumer) via a digital rights agent 28 for the purposes of, for example, issuing a key with which the content consumer can decrypt certain content delivered to the appropriate content destination 22, or for the purposes of, for example, issuing clear content to the content destination 22. The content distributor 20 may also perform update operations with respect to user rights 62 of a content consumer responsive to purchase or subscription actions communicated via a content consumer to the content distributor 20. For example, where the content distributor 20 is a cable network operator, a content consumer may subscribe to particular pay-per-view content, in which case the content distributor 20 updates the user rights 62 for the content consumer to indicate that the user has a right to access the relevant pay-per-view content.

The content destination 22 (e.g., a secure device 46 operated by a content consumer) is shown to request and receive licenses from a digital rights agent 28. In one embodiment, the digital rights agent 28 issues a license on behalf of a content rights owner (e.g., a content provider 16), and a commerce service provider 42 (e.g., a CRM operator) for a content consumer. The license is issued if an access policy associated with the requested content is satisfied, and the content consumer's account is in order. Such a license typically contains a content decryption key, and certain rules governing the use of the decryption key. The content destination 22 is also shown to receive content from the content distributor 20, this content typically being encrypted and requiring the above-mentioned content decryption key for access.

Monitoring Content Streaming

In certain embodiments, content delivered (e.g., streamed) to the content destination 22 may be restricted to a total authorized time duration. For example, a subscriber, user or the like may request and receive streamed content in one or more delivery sessions or access event wherein a cumulative delivery time for the delivery sessions may not exceed the total authorized time duration. Thus, when the sum of each individual access event or streaming session equals the total authorized time duration, the access rights of the user may then be terminated. In one embodiment, the user or content consumer may purchase authorized streaming time in a pre-paid fashion. In other embodiments, the user may purchase authorized streaming time on a monthly subscription basis.

In another embodiment, content delivered to the content destination 20 may be restricted to a certain time segment (e.g. free preview for the first 10 minutes). Thus, the access rights of the user may be terminated at certain points within the stream.

Referring in particular to FIGS. 1 to 4 of the drawings, reference numeral 100 generally indicates a method, in accordance with one embodiment of the invention, for a content destination/consumer 22 to order content via the network 18. In one embodiment, the method may be implemented by an API plug-in 44 to the local content or media server 40.

The method 100 is initiated at block 102, whereafter a user or content consumer browses a website (see browser 90 in FIG. 2) of a network operator or service provider (see block 104) e.g., an Internet broadband service provider. Using the browser 90, the user then selects the particular content which he or she wishes to be streamed to the content destination 22 as shown at block 106. In one embodiment of the invention, the website of the service provider requests login particulars as well as a password (see block 108) thereby to identify the user. Once the content which the user is requesting, as well as authentication credentials are obtained from the user, the operator then creates a session request (see block 110) which is communicated to the digital rights network 39. In response thereto, the digital rights network 39 returns session data or parameters to the operator or service provider (as shown at block 112). The session data typically includes session identification data, agent identification data, and a so called “ticket” which, as described in more detail below, is communicated by the content destination/consumer 22 to a local content or media server 40 (see FIG. 2) when requesting the content. In one embodiment, the session data is then communicated via the service provider to the content destination 22 as shown in block 114. As described above, the content destination may be a PC, a STB, a personal digital assistant (PDA), or any other media terminal to which content may be streamed. Once the content destination 22 has received the session data, the communication session with the service provider may be terminated as shown at block 116.

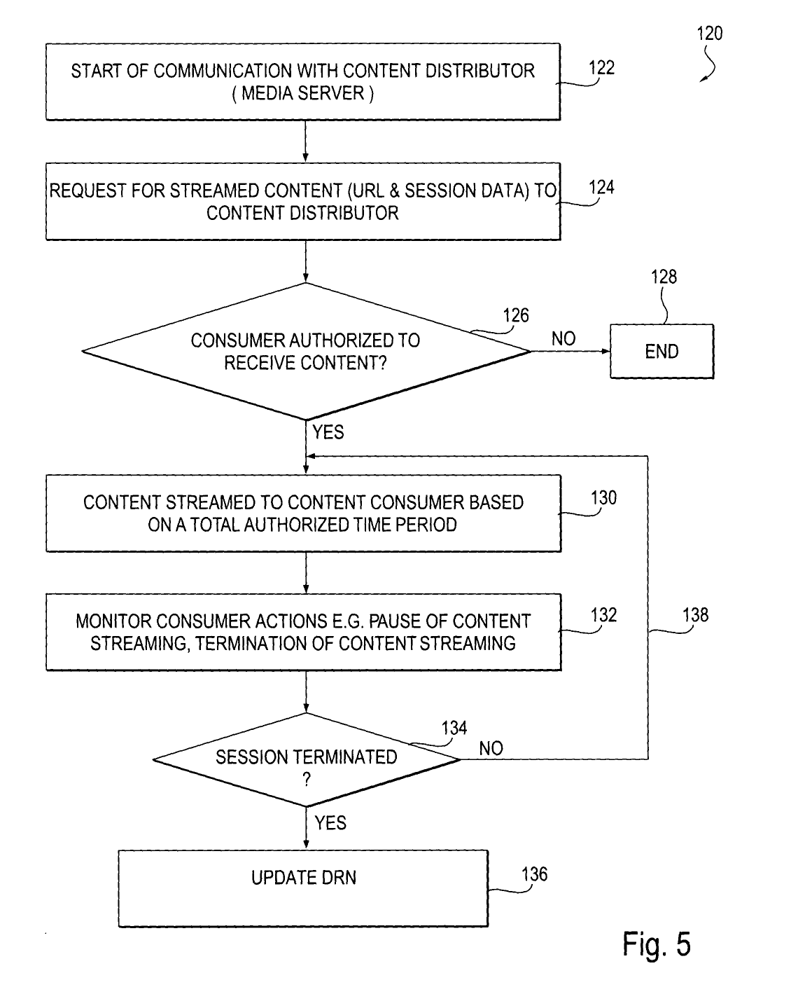

Referring in particular to FIG. 5, reference numeral 120 generally indicates an exemplary embodiment of a method, in accordance within an aspect of the invention, for streaming content from the media server 40 to the content destination or consumer 22. The method 120 starts at block 122 whereafter a request for streamed content (the request being in the form of a URL and session data including the session data) is communicated to the content distributor or media server 40, as shown at block 124. Thereafter, as described in more detail below, the content distributor 20 communicates with the digital rights network 39 to determine whether or not the content destination 22 is authorized to receive the requested content. As shown at decision block 126, when the content destination 22 is not authorized to receive the requested content, the method 120 communicates an appropriate message to the content destination 22, typically in the form of a web page. Thereafter, the method 120 terminates as shown at block 128.

If, however, the content destination 22 is authorized to receive the requested content, the content provider 20 delivers the content by streaming to the content destination 22 based on a total authorized time period (see block 130). As streaming is dependant upon a total amount of streaming time used or consumed by the content consumer 22, at block 132 the content distributor 20 may monitor actions or control events by the content destination 22. For example, actions which pause the streaming of content, or terminate the streaming of content may be monitored so that the content destination 22 is only charged or debited for the actual time or duration during which the content is actually streamed to the content destination 22, and not for any other time periods during which the streaming of the content is paused or terminated (see block 134). When the content consumer 22 terminates streaming of the requested content, the digital rights network 39 is updated with delivered time data (the amount of time that content was actually streamed) as shown at block 136. However, if the session has not been terminated by the content consumer 22, then the method 120, as shown by line 138, returns to block 130 where content is continued to be streamed to the content consumer 22. It is, however, to be appreciated that termination of streaming of the content in decision block 134 may be by the content consumer 22 or by the digital rights network 39, as described in more detail below.

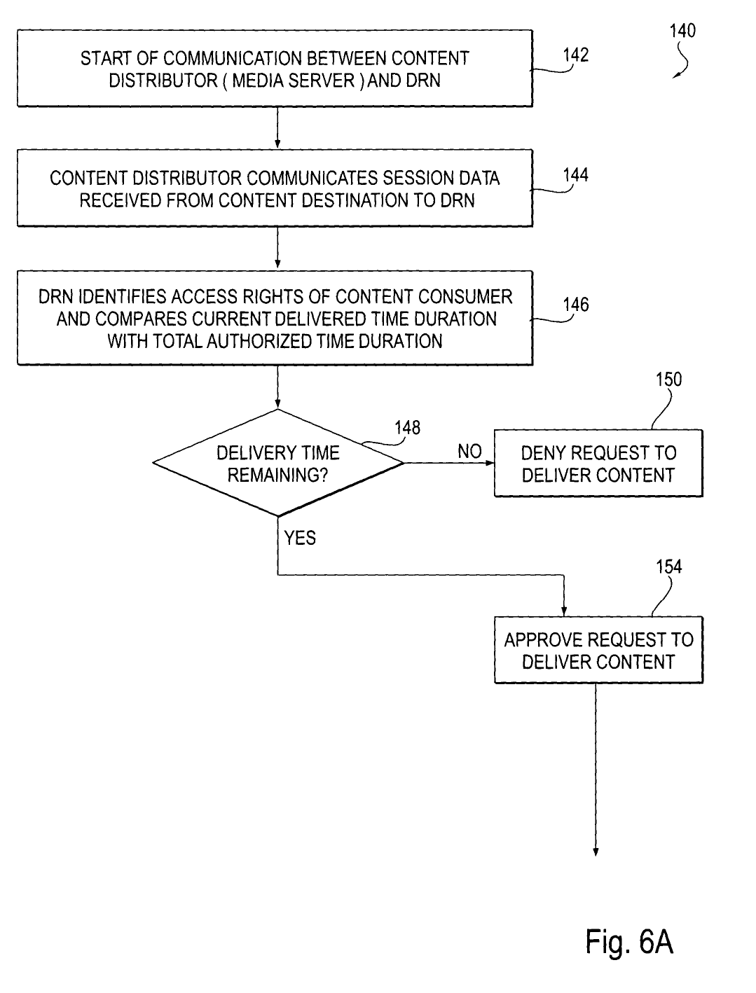

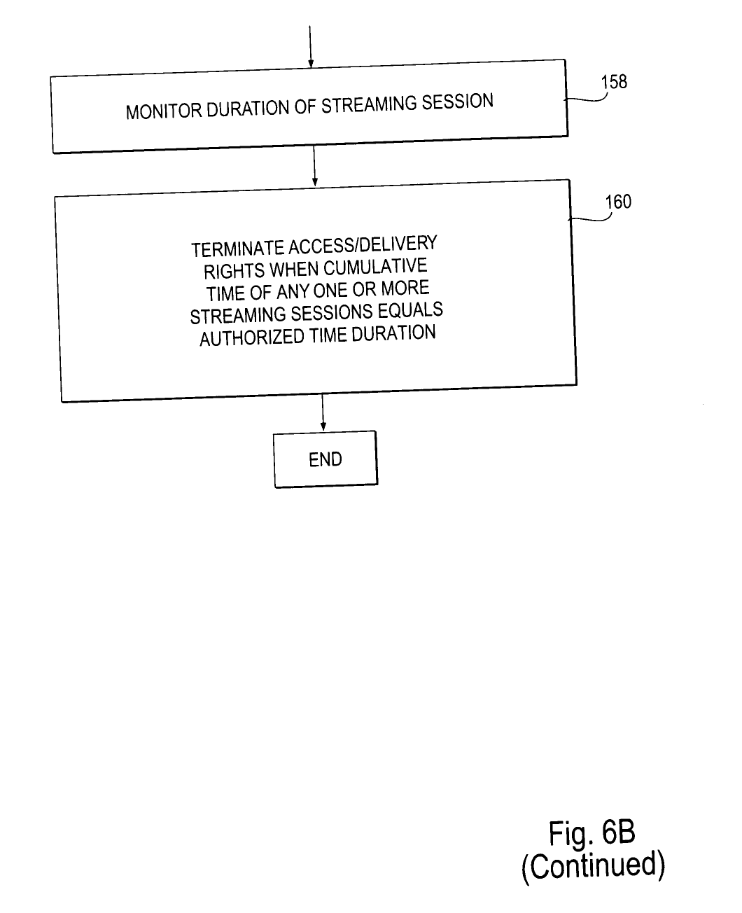

Referring to FIG. 6, reference numeral 140 generally indicates a method, in accordance with an embodiment of the invention, for monitoring the exercise of digital rights via the content consumer or destination 22. The method 140 is initiated when the content distributor 20 receives the request, from the content destination 22, for the inception of the streaming of content from the media server 40. As shown at block 144, the content distributor 20, which receives the session in the appendage to the URL, communicates the session data to the digital rights network 39 (see block 144). Thereafter, the digital rights network 39, in particular the digital rights server 36 (see FIG. 3) accesses data in the content server 56 to obtain content rights and policies 60 associated with the content, and the user server 58 to obtain user rights 62 associated with the content destination 22. Based on the content rights 60 and the user rights 62, the digital rights network 39 may approve or deny the request for streaming rights received from the content distributor 20, as described in more detail below.

In one embodiment the content destination 22 is only authorized to have content streamed to the content destination 22 for a maximum or total authorized time duration. Accordingly, at block 146, the digital rights network 39 identifies the total authorized time duration for which the content consumer or destination 22 may receive streamed content. Content may then be streamed if no content has yet been streamed to the content destination 22 or if there is still time remaining during which the destination 22 may receive content. For example, in one embodiment, the digital rights network 39 monitors the delivered time duration for any one or more sessions during which the content distributor 20 streams content to the content consumer 22 and maintains a current delivered time duration that is stored with the user rights 62. The digital rights network 39 may then compare the current delivered time duration with the total authorized time duration and, if the content consumer 22 no longer has time available, or only has a minimum amount of time available, then the digital rights network 39 may reject or deny the request from the content distributor 20 to stream the content to the destination 22 (see block 150).

In another embodiment the authorized time duration is decremented by the delivery time for each session and further access by the consumer 22 is the denied when the authorized time duration reaches zero. After each delivery session the authorized time duration may be decremented by the delivered time of the particular session to define a new authorized time duration.

In one embodiment, if the particular content consumer 22 does have time remaining, then the digital rights network 39 may determine whether or not the time remaining exceeds a preset amount of time. The preset amount of time is typically such an amount of time so that a meaningful streaming may be initiated (e.g. there is not merely a few seconds of streaming time remaining). As shown at block 154, if there is sufficient time remaining, then the digital rights network 39 may approve the request from the content distributor 20. If, however, the delivery time remaining does not exceed a preset amount of time, then the digital rights network 39 may approve the request from the content distributor 20 but request or instruct the content distributor 20 to communicate a further request for authorization to stream digital content via the network 18 after the preset amount of time remaining. Accordingly, when the number of time units (e.g. minutes or seconds) remaining during which the content consumer 22 may receive content reaches the preset amount, the content provider 20 is required to once again obtain authorization for the streaming of content even though the content destination or consumer 22 may not have terminated the delivery session.

As shown at block 158, during the delivery of content to the content consumer 22, the actual time during which content is streamed to the content destination 22 is monitored. Any pausing or delivery control event of the streaming by the content destination 22 is monitored so that the current delivered time duration reflects the actual time during which content was in fact streamed to the content destination 22, excluding any time during which such streaming or delivery was paused or terminated. As shown at block 160, once the current delivered time duration reaches the total authorized time duration, the digital rights network 39 terminates permission or access rights so that no further content is streamed to the destination source 22. However, the content consumer 22 may purchase further streaming time from the service provider or network operator. As shown at block 162, the method 140 terminates once the content consumer 22 terminates the delivery session or when the total amount of content streamed to the content consumer 22 equals or reaches the total authorized deliver time.

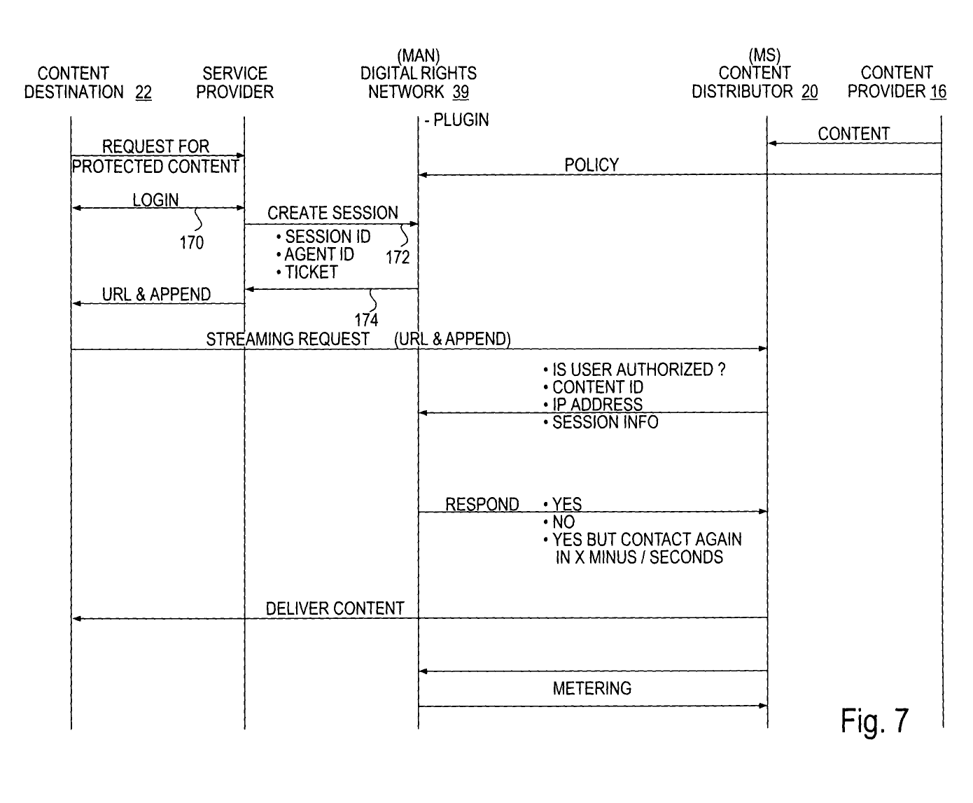

Referring in particular to FIG. 7, broad functionality of the method described above is shown and exemplary Application Program Interfaces (APIs) to implement the methods are set out below.

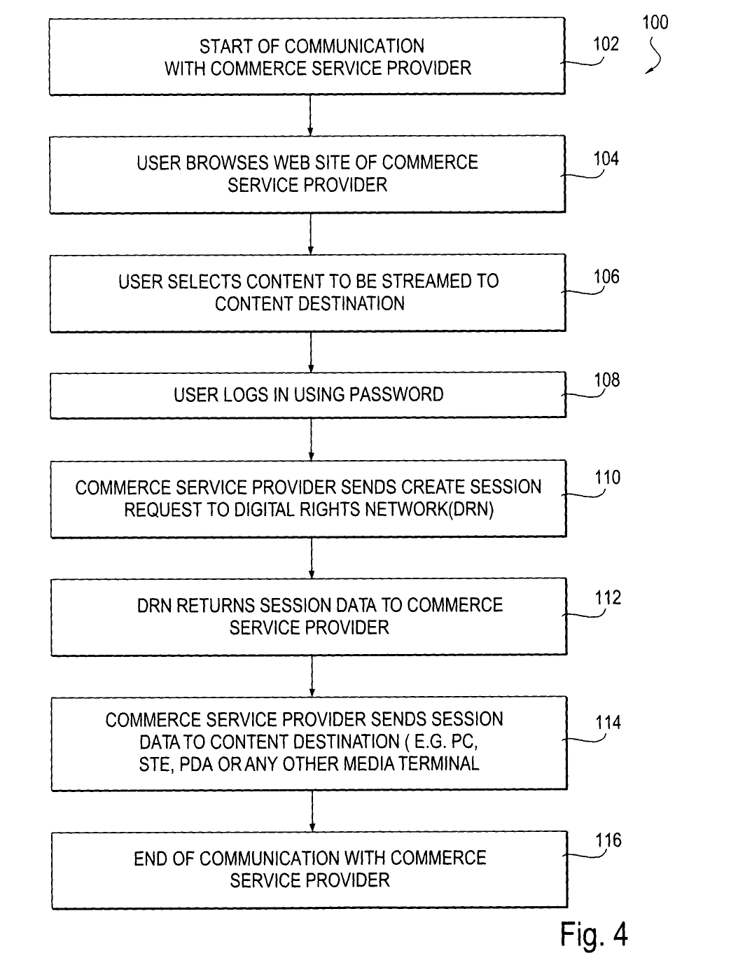

In one embodiment of the invention, a user or content consumer 22 logs into a website of a service provider to request access to protected media or content (see line 170 in FIG. 7 and block 108 in FIG. 4). Thereafter, as shown at line 172 and block 110, the website sends a “create user session” request (see below) to the digital rights network 39. This request informs the digital rights network 39 that the user or content consumer 22 has logged in and, in response thereto, the digital rights network 39 activates the rights for which the user has been authorized (e.g., prepaid minutes, tickets, subscriptions, number of simultaneous streams etc). If the user has not previously registered, a create/update user rights request must first be executed in order to register the user or content consumer 22. The following APIs may be used to perform this functionality: Login User

This client side API is used to login a user and create a session. In one embodiment, the user's id (e.g., email address) and password are used to create the session. In other embodiments, session parameters returned by the “create user session” API are used. HTTPS may be used to submit the user id and password in a secure fashion.

Request

Method: POST
Path: /services/LoginUser
Parameters
   CrmId: Identifies the operator
      Content

The user information may be submitted using the following exemplary form fields:
LeadId
ReturnUrl: After verifying the userid/password or session parameters, the digital rights network may redirect the HTTP request to the URL provided by ReturnUrl.
For userid/password authentication:
   UserId
   Password
Or, for session based authentication:
   SessionId
   Ticket
   AgentHost
Private headers
None

The following is an exemplary implementation of the Login User API:

```
  When the user id and password are submitted, then
  https://man.entriq.net/services/LoginUser?CrmId=mweb
Content
  UserId=john@mweb.co.za
  Password=secret
  LeadId=springbokken.com
  ReturnUrl=http://player.entriq.net/player/userInfo.html
  When the session parameters are used to log in the user:
  http://man.entriq.net/services/LoginUser?CrmId=mweb
Content
  SessionId=0VaziQ81893kLSnmks
  Ticket=7gEyu378902hJKAasukuEWY8929ms2
  AgentHost=MAN
  LeadId=springbokken.com
  ReturnUrl=http://www.mnet.com/player/return.html
Response
```

See Response for “registering a user” set out below with reference to customer care and billing.

Create User Session

This server side API allows a service provider to create a user session when the user logs in to the website. An interface of this API may “activate” the user authorization rights. In one embodiment, the session parameters returned are appended to subsequent streaming media URLs (e.g., for access control) and written to a domain cookie (for digital rights management. If a session already exists for the user, and the IP address of the user matches the IP address of the session, the digital rights network 39 may return existing session information. In one embodiment, an HTTP private header will be provided to indicate that the session was not created. If a session already exists for the user, and the IP address is different, the API may then return an appropriate error code. This error may, for example, occur if users are sharing a username and password.

Request

Method: POST/GET
Path: /services/CreateSession
   Parameters
   CrmId: Identifies the operator
   UserId: Identifies the user/subscriber
   UserIp: IP address of the user, which may be used to:
      lock the session and subsequent media request to the specified IP address. (“0.0.0.0” may be used to avoid IP address locking)
      associate the session with a region (country). “UserCountryId” may be used to override GEO control
   UserCountryId: [optional] ISO 2 character code of the user country to override the network IP based GEO classification
   LeadId: ID of affiliate (sales lead) [optional] used for settlements
   NetworkId: Identifies the network [optional]
   MaxStreams: Number of simultaneous streams during this session [optional, default may be 2]. “0” may be used to allow any number of streams.
   SessionTime: Duration of session in seconds, [optional, default may be 3600 seconds (1 hour)]
   DeviceType (e.g. “WMDRM”): May identify the type of device [optional].

DeviceInfo: May identify the device [optional]

Content

Not applicable in this embodiment

Private Headers

Not applicable in this embodiment

Response

Content

```
<Schema>
  <element name=“Session”>
    <attribute name=“SessionId” type=“string”/>
    <attribute name=“Ticket” type=“string”/>
    <attribute name=“AgentId” type=“string”/>
    <attribute name=“AgentHost” type=“string”/>
    <attribute name=“IpCountry” type=“string”
    occurs=“optional”/>
    <attribute name=“IpCountryConfidence” type=“number”
    occurs=“optional”/>
    <attribute name=“Fraud” type=“number”
    occurs=“optional”/>
  </element>
</Schema>
```

The attributes “SessionId”, “Ticket”, “AgentId” and “AgentHost” need to be appended to any streaming media URL during the session. This allows the media server 40 to verify whether the user is authorized for the requested stream.
The attribute “IpCountry” contains the country as identified using the IP to CEO network intelligence. (The IP to GEO lookup table may be provided by a 3rd party that provides the digital rights network 39 with regular updates).
The attribute “IpCountryConfidence” may optionally indicate the confidence level regarding the IP to GEO classification, and is a number between 0 and 100 (including 0 and 100).
The attribute “Fraud” may optionally be used to indicate whether device related fraud has been detected in previous session with any of the content authorized by the network.
   Private Headers

Not applicable in this embodiment.

The following is an exemplary implementation of the Create User Session API:

```
Request
  <base URL>/CreateSession?
  CrmId=sportnet&UserId=johnson&UserIp=158.12.53.4&NetworkId=
  Cox4&MaxStreams=3&DeviceType=WMDRM
Response
  <Session SessionId=“8378502” Ticket=“gh7G783vgxi298sgyQmhsl”
  AgentId=“agent-1-2” AgentHost=“agent-1” Fraud=“0”
  IpCountry=“US” IpCountryConfidence=“99” Fraud=“0”/>
```

As mentioned above, if a user or content consumer 22 has not previously registered, then the user must first be registered. This may be accomplished using the following exemplary API:

Create/Update User Data

This server side API may be used by server applications to create new or replace all user authorization rights. However, when authorizing a user for a single media or content item or package, it may be more convenient to use a “User Authorize” API (see below). The Create/Update User Data API can also be used by the user or content consumer directly, if authenticated, to update non-rights related user fields such as Name, SecurePassword, SecurePin code, Language or the like. In one embodiment, if a PinMenu Boolean flag is set to “true”, user information will only be updated if the correct PIN has been submitted. To change the current PIN code, the old PIN code may be required in “OldPin” field. As user XML attributes starting with “Secure” may be automatically encrypted with a service provider specific storage key before storage takes place, additional user attributes (e.g., password, PIN code, payment info) may be stored in a secure fashion on the digital rights network 39.

Request

Method: POST
Path: /services/UserData
   Parameters

Not applicable in this embodiment (parameters are retrieved from the XML data)

Content

Client side: Use FORM fields named according to the User XML attributes defined below.

Server side:

```
<Schema>
  <element name=“User”>
    <attribute name=“CrmId” type=“string”/>
    <attribute name=“AccountId” type=“string”
    occurs=“optional”/> <!-- default: UserId -->
    <attribute name=“UserId” type=“string”/>
    <attribute name=“SecurePassword” type=“string”
    occurs=“optional”/>
    <attribute name=“SecurePin” type=“number:4”
    occurs=“optional”/>
    <attribute name=“PinPayment” type=“boolean”
    occurs=“optional”/>
    <attribute name=“PinAmount” type=“number”
    occurs=“optional”/>
    <attribute name=“PinMenu” type=“boolean”
    occurs=“optional”/>
    <attribute name=“PinPG” type=“boolean”
    occurs=“optional”/>
    <attribute name=“PinPGRate” type=“number”
    occurs=“optional”/>
    <attribute name=“Name” type=“string”
    occurs=“optional”/>
    <attribute name=“EmailNotify” type=“boolean”
    occurs=“optional”/>
    <attribute name=“LeadId” type=“string”
    occurs=“optional”/>
    <attribute name=“Debit” type=“number”
    occurs=“optional”/> <!-- default: “0.0” -->
    <attribute name=“Credit” type=“number”
    occurs=“optional”/> <!-- default: “0.0” -->
    <attribute name=“BillDay” type=“number”
    occurs=“optional”/> <!-- 1-31 -->
    <attribute name=“AccessTime” type=“iso8601.time”/> <!--
    default: “00:00:00” -->
    <attribute name=“ATAdd” type=“iso8601.time”/> <!-- See
    documentation -->
    <attribute name=“ATProcessed” type=“iso8601”/> <!--
    default: Now( ) -->
    <attribute name=“ATSchedule” type=“iso8601”/> <!--
    default: “0000-01-00T00:00:00” -->
    <attribute name=“ATCarry” type=“iso8601.time”/> <!--
    default: “00:00:00” -->
    <attribute name=“Begin” type=“iso8601”
    occurs=“optional”/>
    <attribute name=“End” type=“iso8601”
    occurs=“optional”/>
    <attribute name=“PinPayment” type=“boolean”
    occurs=“optional”/>
    <attribute name=“PinAmount” type=“number”
    occurs=“optional”/>
    <attribute name=“PinMenu” type=“boolean”
    occurs=“optional”/>
    <attribute name=“PinPG” type=“boolean”
    occurs=“optional”/>
    <attribute name=“PinPGRate” type=“number”
    occurs=“optional”/>
    <attribute name=“Email” type=“string”
    occurs=“optional”/>
    <attribute name=“Language” type=“string”
    occurs=“optional”/>
    <attribute name=“Country” type=“string”
    occurs=“optional”/>
    <attribute name=“TZ” type=“string” occurs=“optional”/>
    <attribute name=“Bitrate” type=“string”
    occurs=“optional”/>
    <attribute name=“Status” type=“number”
    occurs=“optional”/>
    <element name=“EntitlementList” occors=“once”>
      <element name=“Entitlement”
      occurs=“zeroormore”/>
      <attribute name=“ItemId”
      type=“string”/>
      <attribute name=“AccountId”
      type=“string”
      occurs=“optional”/> <!--
      default: CrmId of User>
      <attribute name=“ChannelId”
      type=“string”
      occurs=“optional”/> <!--
      default: AccountId of
      Entitlement>
      <attribute name=“Begin”
      type=“iso8601”
      occurs=“optional”/>
      <attribute name=“End”
      type=“iso8601”
      occurs=“optional”/>
      <attribute name=“Tickets”
      type=“number”
      occurs=“optional”/>
      <attribute
      name=“TicketDuration”
      type=“iso8601”
      occurs=“optional”/>
      <attribute name=“SubString”
      type=“boolean”
      occurs=“optional”/> <!--
      default: “false” -->
    </element>
  </element>
  </element>
</Schema>
```

CrmId: Identifies the user operator (service provider)
UserId: Identifies the user for the specified operator. The user ID should be unique in the domain of the operator, and in one embodiment can be any combination of alphanumeric characters, “@”, “_” or “.” symbol.
SecurePassword: Securely stored password to identify (authenticate) the user. Storing this parameter in the authorization network allows the network to securely perform the user authentication.
SecurePin: 4 digits containing securely stored PIN code.
PinPayment: Boolean to indicate whether purchase services are blocked using PIN code.
PinAmount: Number to indicate value of payments that require a PIN code.
PinMenu: Boolean to indicate whether user settings menu is blocked using PIN code.
PinPG: Boolean to indicate whether rated programming is blocked using PIN code.
PinPGRate: Number to indicate starting which rate of programming that is blocked using PIN code.
EmailNotify: Boolean to indicate whether user should be notified by email for special events (including billing).
AccountId: Optional attribute to group users into accounts (e.g. employees of a company, household members, etc).
AccessTime: This attribute is used to implement the time-constrained model, or to constrain the access time of a user for an authorized delivery time period (in accordance with one embodiment of the invention and as herein described. The attribute may contain the amount of time (total authorized delivery/access time) that a user can access content that requires “AccessTime” according to the content access policy. As mentioned above, the digital rights network 39 automatically updates the AccessTime (the authorized delivery time period) attribute while the user is accessing the content. The digital rights network 39 will stop access to the content once the value reaches “00:00:00”.
ATAdd, ATProcessed, ATSchedule, ATCarry: These attributes may be used automatically to increase the AccessTime value to a certain value on a regular (e.g. monthly) basis:
   ATAdd: This attribute may define the amount of time by which the AccessTime attribute will be increased.
   ATProcessed: This attribute may contain the last date that the AccessTime was updated.
   ATSchedule: This may attribute contain the period interval between updates
   ATCarry: This attribute may contain the maximum amount of time that a user can carry to a next period.

Exemplary Pseudo code to implement this invention is as follows:

```
if ATAdd has a valid time value then
  if ATProcessed + AtSchedule > Now then
    AccessTime = AccessTime + ATAdd
    if ATCarry > 0 and AccessTime > ATCarry then
      AccessTime = ATCarry
    end if
    ATProcessed = Now
  end if
end if
```

Begin: This attribute may be used to set the start date and time of all user authorization rights. Begin date and time can also be set for individual entitlements (see below).
End: This attribute may be used to set the end date and time of all user authorization rights. The end date and time can also be set for individual entitlements (see below).
Status: This attribute may be used to deactivate all user rights, by setting it to a value other than 0 (default). The digital rights network will automatically set this value when media fraud is suspected. The status attribute value may set to an appropriate error code.
EntitlementList: May contain a set of entitlement elements, defining the authorization rights of a user.
Entitlement: A single authorization right of a user, representing the rights to access a single content item of a group of content items (e.g., subscription). An entitlement may have one or more of the following exemplary attributes:
   ItemId: Identifies the entitlement
   AccountId: This attribute, in combination with the “ItemId” attribute, identifies the entitlement in case the content item is registered by a 3rd party operator (syndication).
   ChannelId: This attribute can be used to store a channel through which the entitlement has been received. In one embodiment, it is not used by the authorization network to verify the rights, so the channel ID does not need to be set. It can be used to generate a “My favorites” list from the entitlements.
   Begin: Users will only be authorized to access associated content after the “Begin” attribute.
   End: Users will only be authorized to access associated content until the “End” attribute.
   Tickets: Tickets may be used in combination with the “TicketDuration” attribute, and enable an operator to grant tickets for later consumption. When the user is granted a ticket and subsequently accesses the content, the network may:
      decrement the number of tickets (if the user is not entitled according to current “Begin” and “End” attributes), set the “Begin” attribute to the current time and set the “End” attribute to the current time+“TicketDuration” until it reaches “0” tickets;
      not set the “End” attribute if the “TicketDuration” attribute is not specified (endless subscription);
      not provide access to associated content if the “Tickets” attribute is set to 0, and the “Begin” and “End” attributes indicate the entitlement has expired;
      provide access to associated content if the “Tickets” attribute is set to 0, the “Begin” attribute has been set and is valid or has not been set, and the “End” attribute has not been set.
      In one embodiment, the “Begin” and “End” attributes must be set to an empty string when assigning tickets to an entitlement for the first time.
   TicketDuration: See “Tickets” above.
   SubString: This attribute can be used to provide a user access to a number of related content items, such as all bit rates or formats. If set to true, the user is authorized for any content item that includes the ItemId as a SubString.

The following additional XML attributes are optional and, in one embodiment, used in combination with an Account Manager and a User Manager user interface.
LeadId: This attribute can be used to identify the account id of the sales lead (sales reference).
Debit, credit: These attributes can be used by the operator to store user purse information. The network may use these attributes to automatically clear transactions for high peek events using prepaid wallets.
Name, Email, Language, Country, TZ (TimeZone), Bit rate: These attributes need not used by the network, but may be used by the operator to store user settings or preferences.

In one embodiment, multiple users can be registered in a single HTTP message by embedding multiple user XML documents within a single <Batch/>element.

Private Headers

The Create/Update User data request may be accompanied by a private header containing transaction information, in case the authorization request is coupled with a financial transaction. This data may be used to enable settlements and commission schemes across a pay media value chain. The request may also be accompanied by a private header containing subscription information, in case the authorization request is coupled with a recurring subscription. The data may also be used to enable clearing, settlements and commission schemes across the pay media value chain and may be used for logging and monitoring.

Response

Content

Not applicable in this embodiment

Private Headers

Not applicable in this embodiment

An exemplary implementation of this API is as follows:

```
Request
  https://man.entriq.net/services/UserData
Content
  <User CrmId=“MWEB” UserId=“john@mail.com”
  SecurePassword=“secret”
  SecurePin=“****” PinMenu=“true” PinPG=“true” PinPayment=“true”
  PinAmount=“0” PinPGRate=“13” AccessTime=“01:12:00” TZ=“−5.0”
  Language=“eng” Country=“US” Name=“Dr John”
  Email=“john@mail.com”>
  <EntitlementList>
      <Entitlement ItemId=“Sports” End=“2001-05-
      05T12:00:00”/>
      <Entitlement ItemId=“Premium”/>
      <Entitlement ChannelId=“soccer”
      ItemId=“Game20021215ASRomaVSInter”
      SubString=“true”/>
      <Entitlement AccountId=“ESPN” ItemId=“NBA”
      Begin=“2001-05-05T11:20:00” End=“2001-05-
      06T11:20:00” Tickets=“1” TicketDuration=“0000-00-
      01T00:00:00”/>
      <Entitlement AccountId=“ESPN” ItemId=“soccer”
      Begin=“” End=“” Tickets=“1” TicketDuration=“0000-
      00-01T00:00:00”/>
      <Entitlement AccountId=“ESPN” ItemId=“NHL”/>
  </EntitlementList>
</User>
```

As mentioned above, authorization for use of a single content item may be carried out by an authorize API:

Authorize

This exemplary server side API may be used to authorize a user or content consumer 22 for a specific package or media item. The digital rights network 39 may update the user rights according to a policy associated with the specified content (media item or package), and create a transaction with the necessary details to enable tracking for settlements between the content provider 16 and the content distributor 22. In one embodiment, the request is sent to a digital rights agent 28 (or agent cluster) that has been assigned to a particular session. An exemplary hostname of the agent 28 can be found in the Create User Session response (see above).

Request

Method: GET/POST
Host: /<agent cluster hostname>.entriq.net
Path: /services/Authorize
   Parameters
CrmId: identifies operator
UserId: identifies user
ContentAccountId: Identifies the “owner” of the content (content provider 16). [Optional, default=CrmId]
ContentChannelId: Identifies the content channel [not required for packages]
ContentItemId: Identifies the media id or package id
SessionId: Identifies the session that has been established for the user
UpdateBalance: Boolean to indicate whether the balance (debit/credit) of the user should be updated [default=false]. This is needed when the user's wallet is maintained by the digital rights network 39.
   Content

Not applicable in this embodiment

Private Headers

Not applicable in this embodiment

An exemplary implementation of this API is as follows:

Request

Exemplary authorization request for single syndicated media item:

https://man.entriq.net/services/Authorize?CrmId=sportnet&UserId=
john@home.com&ContentAccountId=supersport&ContentChannelId=
soccer&ContentItemId=game123&SessionId=81765487

Exemplary authorization request for a package provided by the operator (“sportnet”):

https://man.entriq.net/services/Authorize?CrmId=sportnet&UserId=
john@home.com&ContentItemId=basic&SessionId=81765487

Returning to FIG. 7, as shown by line 174 and block 112, the create session request returns session data or parameters (e.g., an agent id, an agent host, a session id, a ticket, or the like) to be appended by the website to each streaming media URL if a content stream is protected, see line 406. In one embodiment, the parameters are validated by an Entriq media server authorization plug-in when the user starts to receive streamed content. In one embodiment, the parameters are not appended for streams that are protected by digital rights management such (such as content that is downloaded as opposed to content that is streamed). If the user or content consumer 22 has requested access to encrypted (digital rights management) content, the digital rights network 39 may authenticate the user for any subsequent player license request.

However, when content is delivered to the user or content consumer 22 by streaming, at any time during a particular streaming session, the website may query session authorization information (see exemplary API set out below) to determine appropriate sales details (e.g., price) to authorize the user for a certain package/event. In one embodiment, this occurs when the user requests a package (e.g. during subscription), a single content item (e.g., a pay-per-view item) or when the user wants to purchase prepaid time for streaming content to the user upon demand. In one embodiment, simple business logics (such as a simple membership setup) may favor hard-coding this data in the website.

Query session authorization

Using this server side API, a content distributor 22 can request whether a user session is authorized for a specific media item, package or channel (see line 408). A response from the digital rights network 39 (see line 410) indicates whether the user is authorized, and if not, the appropriate policy that should be applied (payment etc). In one embodiment, the request is sent to the agent 28 that has been assigned to the session. As in the case mentioned above, the hostname of the agent 28 can be found in the create user session response (see above).

Request

Method: POST/GET
Host: /<agent cluster hostname>.entriq.net
Path: /services/QuerySessionAuthorization
   Parameters
SessionId: Identifies the session
ContentAccountId: Identifies the account ID of the content provider that registered the content.
ContentChannelId: Identifies the channel ID of the content.
ContentItemId: Uniquely identifies the content item within the channel.

In certain embodiments:
To request individual content (media file/event) information, both the “ContentChannelId” and “ContentItemId” may be specified in the in the HTTP request.
To request general channel information, the “ContentItemId” may be omitted or set to an empty string.
To request package information, the “ContentChannelId” may be omitted or set it to an empty string.
   Content

Not applicable in this embodiment

Private Headers

Not applicable in this embodiment

Response

Content

```
  <Schema>
  <element name=“AuthorizationInfo”>
    <attribute name=“Authorized” type=“boolean”/>
    <attribute name=“ErrorCode” type=“number”/>
    <attribute name=“ErrorMessage” type=“string”/>
    <element name=“Content”/> !--(media XML element)
    <element name=“SubPolicy”/> !--(sub policy XML
    element)
    <element name=“Entitlement”/> !--(user/entitlement
    XML element)
  </element>
</Schema>
```

The attribute “Authorized” may be set to “true” if the session is authorized, or “false” otherwise.
The attribute “ErrorCode” and “ErrorMessage” may indicate a highest level reason for authorization failure.
The attribute “ErrorCodes” may give a list of ALL error codes encountered for that session and content request.
If authorized, the element “Entitlement” may contain the applicable user entitlement.
The element “Content” may contain appropriate content information. This may be a media item, package or channel.
The element “SubPolicy” may contain an applicable access policy.
   Private Headers

A user rights XML document may be attached to the response in a private HTTP header if the requesting account “owns” the user session.

An exemplary implementation of the API is as follows:

Request

Query authorization information for a specific content/media item:

http://man.entriq.net/services/QuerySessionAuthorization?SessionId=
1234&ContentAccountId=private&ContentChanneldId=sports&
ContentItemId=movie300_scene003

Query authorization information for a specific channel:

http://man.entriq.net/services/QuerySessionAuthorization?SessionId=
1234&ContentAccountId=private&ContentChanneldId=sports

Query authorization information for a specific package:

http://man.entriq.net/services/QuerySessionAuthorization?SessionId=
1234&ContentAccountId=private&ContentItemId=basic

Response

The following provides an exemplary response when the session request is authorized for a particular content/media item:

```
<AuthorizationInfo Authorized=“true”>
  <Content AccountId=“espn” ChannelId=“soccer”
  ItemId=“20021213LIVvsMAN_300” PolicyId=“basic” Name=
  “Liverpool vs Manchester United” Description=“...”
  LongDescription=“...”
  MediaType=“VIDEO”/>
  <SubPolicy AccountId=“espn” PolicyId=“basic” SyndicatorId=“msn”
  Priority=“3” Country=“wo” Payment=“true” Price=“5.00”
  Package=“true” PackageItemId=“basic”/>
</AuthorizationInfo>
```

The following is an exemplary response when the session request is not authorized for a particular content/media item:

```
<AuthorizationInfo Authorized=“false” ErrorCode=“201”
ErrorCodes=“201” ErrorMessage=“No valid entitlement”>
  <Content Type=“MEDIA” AccountId=“espn” ChannelId=“soccer”
  ItemId=“20021213LIVvsMAN_300” PolicyId=“basic” Name=
  “Liverpool vs Manchester United” Description=“...”
  LongDescription=“...”
  MediaType=“VIDEO”/>
  <SubPolicy AccountId=“espn” PolicyId=“basic” SyndicatorId=“msn”
  Priority=“3” Country=“wo” Payment=“true” Price=“5.00”
  Package=“true” PackageItemId=“basic”/>
</AuthorizationInfo>
```

The following provides an exemplary response when a session request is authorized for a channel:

```
<AuthorizationInfo Authorized=“true”>
  <Content Type=“CHANNEL” AccountId=“espn” ChannelId=“soccer”
  PolicyId=“game” Name=“ESPN soccer” Description=“...”
  LongDescription=“...” />
  <SubPolicy AccountId=“espn” PolicyId=“basic” SyndicatorId=“msn”
  Priority=“3” Country=“wo” Payment=“true” Price=“5.00”
  Package=“true” PackageItemId=“basic”/>
</AuthorizationInfo>
```

The following provides an exemplary response when session request is authorized for a particular package:

```
<AuthorizationInfo Authorized=“true”>
  <Content Type=“PACKAGE” AccountId=“espn” ItemId=“basic”
  PolicyId=“30dollarpermonth” Name=“Basic Package” Description=“...”
  LongDescription=“...” />
  <SubPolicy AccountId=“msn” PolicyId=“30dollarpermonth”
  SyndicatorId=“msn” Priority=“3” Country=“wo” Payment=“true”
  Price=“30.00” Recurring=“true” Package=“false”/>
</AuthorizationInfo>
```

Subsequently, the website may authorize a user for a new package/event using the exemplary Authorize API, or post new user rights using the Create/Update User Data API, as described above. In one embodiment, the user may then be automatically authorized to access the associated media.

In one embodiment, at any time during the session, the website may query the current session status to verify the last authorization error, the number of active streams, the total amount streamed, or the like using the APIs set out below.

Query User Session

Query User Session is a server side API that allows a service provider or affiliated content provider to request the state of a current session. The exact response to this request may depend on whether the requesting application is the service provider (who created the session) or an affiliated content provider. Certain data may only be visible to the service provider. The request may be sent to the digital rights agent 28 that has been assigned to the session. The hostname of the agent 28 may be found in the create user session response.

Request

Method: POST/GET
Host: /<agent cluster hostname>.entriq.net
Path: /services/QuerySession
   Parameters
   SessionId: Identifies the session
      Content

Not applicable in this embodiment

Private Headers

Not applicable in this embodiment

Response

Content

```
<Schema>
<element name=“Session”>
    <attribute name=“SessionId” type=“string”/>
    <attribute name=“CrmId” type=“string”/>
    <attribute name=“AccountId” type=“string”/>
    <attribute name=“UserId” type=“string”/>
    <attribute name=“UserIp” type=“string”/>
    <attribute name=“Country” type=“string”/>
    <attribute name=“IpCountryConfidence” type=“string”/>
    <attribute name=“NetworkId” type=“string”/>
    <attribute name=“DeviceType” type=“string”/>
    <attribute name=“DeviceId” type=“string”/>
    <attribute name=“TimeStamp” type=“iso8601”/>
    <attribute name=“ExpTime” type=“iso8601”/>
    <attribute name=“NoStreams” type=“number”/> (*)
    <attribute name=“MaxStreams” type=“number”/> (*)
    <attribute name=“StartStream” type=“iso8601”/> (*)
    <attribute name=“StreamTime” type=“number”/> (*)
    <attribute name=“StreamBytes” type=“number”/> (*)
    <attribute name=“LeadId” type=“string”/> (*)
    <attribute name=“Error” type=“number”/> (*)
    <attribute name=“ErrorMessage” type=“string”/> (*)
  </element>
</Schema>
(*) Only returned in this embodiment if the requesting application
“owns” the session, see “Private headers” for further information
```

See Create Session API for exemplary session attributes.
The attribute “TimeStamp” may contain the recorded creation date and time of the session.
The attribute “ExpTime” may contain the session expiration date and time.
The attribute “NoStreams” may contain the number of streams that the user is currently viewing. In certain embodiments, this number may be higher than actual streams if the media server 40 fails to reach the digital rights network 39 when the user stops streaming the content to the destination device 22.
The attribute “StartStream” may contain the date and time of the last streaming media server authorization request.
The attribute “StreamTime” may contain the total number of seconds that the user has streamed since the start of the session.
The attribute “StreamBytes” may contain the total amount of bytes that the user has streamed since the start of the session.
The attribute “Error” may contain a numeric error code of the LAST exception that occurred since the start of the session.
The attribute “ErrorMessage” may contain a description of the LAST exception that occurred since the start of the session.
The attribute “IpCountryConfidence” may be empty in case the Country of the user was explicitly defined by the service provider when the session was created (instead of using the IP GEO service).
   Private Headers

The user rights XML document (see Create/Update User Data API) may be attached to the response in the private HTTP header. In one embodiment, if the requesting application does not “own” the session, the user XML element will only contain the entitlements that are specific to the requesting application account. The CrmId, AccountId and UserId of the session may also be returned, but may be encrypted if requested by the owner of the session. Accordingly, the content provider may store user/account specific settings for “personalization” while keeping the user identity anonymous.

An exemplary implementation of this API is as follows:

```
Request
http://man-1.entriq.net/services/QuerySession?SessionId=1234
Response
Content
  <Session Id=“123” CrmId=“msn” UserId=“pietje” UserIP=“10.2.12.45”
  NetworkId=“” DeviceType=“PC” DeviceId=“”
  TimeStamp=“2002-05-15T21:04:34”
  ExpTime=“2002-05-15T23:04:34” NoStreams=“1” MaxStreams=“2”
  StartStream=“2002-05-15T21:22:09” GUID=“” StreamTime=“857”
  StreamBytes=“8234893” Country=“us” CountryIpConfidence=“99”
  AffiateId=“”
  Error=“214” ErrorMessage=“User is not entitled for requested
  content”/>
```

As in the case above where the website may query the current session status, the website may also request current user data using an exemplary Get User Data API set out below. The website may, at any time, request current user data as the digital rights network 39 may have dynamically changed the user rights (e.g., in the case of Prepaid Minutes or Ticket based business models).

Get User Data

This server side API allows user data to be retrieved from the digital rights network 39 to verify current user authorization rights. In one embodiment, user data is stored using an XML structure, allowing storage of additional information with the user rights (such as name, password, or email address). The digital rights network 39 may only process the “access rights” XML tags as defined in the XML data specification, and may ignore any other data that may have been included. User XML attributes starting with “Secure” may be automatically encrypted with a service provider specific storage key before storage takes place. This allows the service provider to store additional user attributes (e.g., password, PIN code, payment info) in a secure fashion on the digital rights network.

Additional user data such as transactions, subscriptions and generic events (history) may be queried in the same request by setting the appropriate Boolean parameters in the request to “true”. An exemplary Get User Data request is as follows:

Request

Method: GET
Path: /services/UserData
   Parameters
CrmId: identifies operator
UserId: identifies user
TransactionList: Boolean indicating whether response should include registered transactions (default=false)
SubscriptionList: Boolean indicating whether response should include registered subscriptions (default=false)
UserEventList: Boolean indicating whether response should include registered user events (default=false)
   Content

Not applicable in this embodiment

Response

Content

<User/>

The Post User Data API below provides an exemplary specification of a User XML specification.

```
Private headers
    MAN-transaction-list:
<TransactionList><Transaction/>...</TransactionList>
    MAN-subscription-list
<SubscriptionList><Subscription/>...</SubscriptionList>
    MAN-user-event-list
<UserEventList><UserEvent/>...</UserEventList>
```

An exemplary implementation of this API is as follows:

<base URL>/UserData?Crmld=sportnet&UserId=johnson

When a user has logged off from the website, the operator may explicitly request the digital rights network 39 to delete the session before any default session expiration time. This may help to reduce potential user fraud. An exemplary API to execute this functionality is set out below.

Delete User Session

This exemplary server side API allows a user session to be explicitly deleted when a user logs off from the website. This may prevent users with the same IP address from time-sharing user sessions. In one embodiment, the request is sent to the agent 28 that has been assigned to the session. As mentioned above, the hostname of the agent 28 can be found in the create user session response.

Request

Method: POST/GET
Host: /<agent cluster hostname>.entriq.net
Path: /services/DeleteSession
   Parameters
SessionId: Identifies the session
   Content

Not applicable in this embodiment

Private Headers

Not applicable in this embodiment

Response

Content

Not applicable in this embodiment

Private Headers

Not applicable in this embodiment

An exemplary implementation of this API is as follows: <base

URL>/DeleteSession?CrmId=sportnet&UserId=johnson&SessionId=928374

Various other APIs (see below) may be provided in certain embodiments to enhance management functionality of the digital rights network 39.

Delete User

This server side API allows users to be deleted from the system, for example, if they are no longer active.

Request

Method: GET/POST
Path: /services/UserDelete
   Parameters
CrmId: identifies operator
UserId: identifies user
   Content

Not applicable in this embodiment

In one embodiment of the invention, the following exemplary network management API may reside on the media server 40 of a content distributor 20. The API may be used by the media server 40 to send authorization requests to the digital rights network 39, for example, to prevent fraud and enable detailed logging and monitoring of streaming of content to the content consumer 22. In one embodiment, the media server 40 sends “media events” to the digital rights network 39 when the content consumer 22 starts, stops or pauses the streaming of the content. As described above, the digital rights network 39 may log the event, verify access rights of the user or content consumer 22, and return a “go” (allow delivery of content) or “no-go” (e.g., deny delivery of content) to the media server 40. Further, as mentioned above, when the digital rights network 39 grants the content distributor 20 to deliver content to the content consumer 22 (e.g., a “go” response is sent) the digital rights network 39 may also indicate that the media server 40 needs to callback within a certain time period (see block 156 in FIG. 6).

An exemplary request sent by the content distributor 20 is as follows:

Request

Method: GET/POST
Path: /MediaEvent
   Parameters
SessionId:
ClientIp:
ContentTag:
Event (Connect, Disconnect, Start, Pause, Stop, Timer)
PlayerGuid
BytesSent
AvgBitRate
StreamTime
Position
NpId
   Response
   Private headers
MAN-callback-timeout
MAN-callback-level

In one embodiment, the digital rights network 39 provides standard Windows Media and Real authorization plugins that implement the methods described above, which may be downloaded online.

Computer System

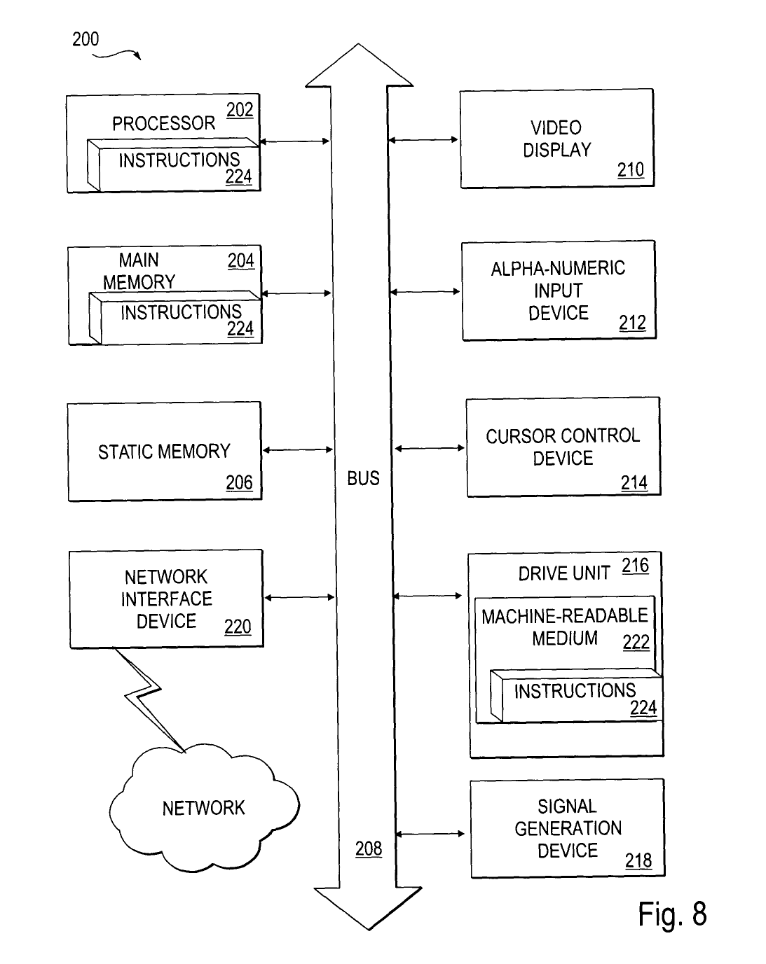

FIG. 8 is a diagrammatic representation of a machine in the form of computer system 200 within which software, in the form of a series of machine-readable instructions, for performing any one of the methods discussed above may be executed. The computer system 200 includes a processor 202, a main memory 204 and a static memory 206, which communicate via a bus 208. The computer system 200 is further shown to include a video display unit 210 (e.g., a liquid crystal display (LCD) or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220. The disk drive unit 216 accommodates a machine-readable medium 222 on which software 224 embodying any one of the methods described above is stored. The software 224 is shown to also reside, completely or at least partially, within the main memory 204 and/or within the processor 202. The software 224 may furthermore be transmitted or received by the network interface device 220. For the purposes of the present specification, the term “machine-readable medium” shall be taken to include any medium that is capable of storing or encoding a sequence of instructions for execution by a machine, such as the computer system 200, and that causes the machine to perform the methods of the present invention. The term “machine-readable medium” shall be taken to include, but not be limited to, solid-state memories, optical and magnetic disks, and carrier wave signals.

If written in a programming language conforming to a recognized standard, the software 224 can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine, such as the computer system 200, to perform an action or a produce a result.

Thus, a distributed digital rights network, and methods of accessing, operating and implementing the same, has been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A media delivery network, which includes:
a media server to store content to deliver to a content consumer upon demand; and
a digital rights server to store content consumer rights defining access rights of a content consumer with respect to content, and content owner rights defining access policies to the content as established by a content owner,
wherein the delivery of the content to the content consumer is timed and the access rights of the content consumer are updated in response to a delivered time during which the content was delivered to the content consumer.

2. The network of claim 1, wherein a delivery control event initiated by the content consumer is monitored and, in response to the event, timing of the content delivery is at least paused.

3. The network of claim 1, wherein the digital rights server includes content owner rights of a plurality of content providers each of which have associated content owner rights defining access policies to the content provided by an associated content owner.

4. The network of claim 1, wherein further delivery is denied after a cumulative delivered time reaches an authorized time duration associated with the content consumer.

5. The network of claim 4, wherein the media server communicates with the digital rights server to obtain authorization to deliver the content to the content consumer, and communicates the delivered time to the digital rights server, wherein the delivered time is a time period for which the content was actually delivered to the content consumer in a particular delivery session.

6. The network of claim 1, wherein further delivery is denied after a certain position within the media has been reached.

7. The network of claim 4, wherein the digital rights server decrements the authorized time duration by the delivery time to define a new authorized time duration for a subsequent delivery session.

8. The network of claim 4, wherein the digital rights server stores an access period during which the authorized time duration is valid.

9. The network of claim 3, which includes at least one network operator associated with the content provider, wherein the network operator, in response to a request for the content from the content consumer, communicates with the digital rights server to obtain session data from the digital rights server, and the media server selectively delivers the content based on the session data.

10. The network of claim 9, wherein the media server communicates the session data to the digital rights network that processes the session data and, in response thereto, selectively authorizes streaming of the media for at most the authorized time duration.

11. The network of claim 10, which includes a digital rights agent to control access operations relating to the content consumer rights and the content owner rights, wherein the access operations include a first access operation with respect to the content consumer rights and a second access operation with respect to the content owner rights.

12. The network of claim 11, wherein the first access operation is performed by a commerce service provider with which the content consumer has a relationship.

13. The network of claim 11, wherein the second access operation is performed by the content owner.

14. The network of claim 11, wherein the access operations include any one of a rights query, a rights update, a rights registration, a rights de-registration and a rights exercise operation.

15. The network of claim 1, wherein the content consumer rights are acquired from a content distributor with which the content consumer has a relationship.

16. The network of claim 1, wherein digital rights server:
determines an amount of authorized delivery time remaining; and
requests the media server to communicate with the digital rights server after expiry of a time period equal to about the delivery time remaining.

17. A method of controlling the delivery of content from a media server that stores content to deliver to a content consumer upon demand, the method including: defining, at a digital rights server, access rights of a content consumer with respect to content, and content owner rights defining access policies to the content as established by a content owner;
timing delivery of the content to the content consumer; and
updating the access rights of the content consumer in response to a delivered time during which the content was delivered to the content consumer.

18. The method of claim 17, which includes monitoring a delivery control event initiated by the content consumer and, in response to the event, pausing timing of the content delivery.

19. The method of claim 17, wherein the further delivery is denied after a cumulative delivered time reaches an authorized time duration.

20. The method of claim 19, which includes defining content owner rights of a plurality of content providers each of which have associated content owner rights defining access policies to the content provided by an associated content owner.

21. The method of claim 19, in which the media server communicates with the digital rights server to obtain authorization to deliver the content to the content consumer, and communicates the delivered time to the digital rights server, wherein the delivered time is the time period for which the content was delivered to content consumer in a particular delivery session.

22. The method of claim 19, which includes decrementing the authorized time duration by the delivery time to define a new authorized time duration for a subsequent delivery session.

23. The method of claim 17, which includes:
determining, at the digital rights server, an amount of distribution time remaining; and
requesting the media server to communicate with the digital rights server after expiry of a real time period equal to about the delivery time remaining.

24. The method of claim 19, which includes:
receiving a request for session data from a network operator; and communicating the session data from the digital rights server to a network operator, wherein delivery of the content from the media server is based on the session data.

25. The method of claim 24, which includes communicating the session data from the media server to the digital rights server that processes the session data and, in response thereto, selective authorizing delivery of the media for at most the authorized time duration.

26. The method of claim 17, which includes acquiring the content consumer rights from a content distributor with which the content consumer has a relationship.

27. The method of claim 17, which includes associating a certificate with the content consumer, and attributing the content consumer rights to the content consumer utilizing the certificate, the content consumer rights being acquired from the plurality of network operators.

28. A method of monitoring the exercise of digital rights by a content consumer, which includes:
receiving a session request from a network operator server, the session request being associated with delivery of content from a media server to the content consumer;
communicating session data to the network operator server, the session data being for communication to the media server; and
receiving a delivery request from the media server, the delivery request including the session data;
timing delivery of the content to the content consumer; and
updating access rights of the content consumer in response to a delivered time during which the content was delivered to the content consumer.

29. The method of claim 28, which includes denying further access after a cumulative delivered time reaches an authorized time duration associated with the content consumer.

30. The method of claim 29, which includes defining access rights of a content consumer with respect to content, and wherein the access rights of the content consumer define the authorized time duration.

31. The method of claim 28, wherein the digital rights server includes content owner rights of a plurality of content providers each of which having associated content owner rights defining access policies to the content provided by an associated content owner.

32. The method of claim 31, which includes receiving the delivered time received from a media server, the delivered time being the time period for which the content was delivered to content consumer in a particular delivery session.

33. The method of claim 30, which includes decrementing the authorized time duration by the delivery time to define a new authorized time duration for a subsequent delivery session.

34. The method of claim 33, which includes:
determining an amount of authorized delivered time remaining; and
requesting the media server to communicate with the digital rights server after expiry of a time period equal to about the delivery time remaining.

35. A media delivery network, which includes:
media server means for storing content to distribute to a content consumer upon demand; and
digital rights server means for storing content consumer rights, defining access rights of a content consumer with respect to content, and content owner rights defining access policies to the content as established by a content owner, wherein the delivery of the content to the content consumer is timed and the access rights of the content consumer are updated in response to a delivered time during which the content was delivered to the content consumer.

36. A machine-readable medium storing a sequence of instructions that, when executed by a machine, cause machine to:
define, at a digital rights server, access rights of a content consumer with respect to content, and content owner rights defining access policies to the content as established by a content owner;
time delivery of the content to the content consumer; and
update the access rights of the content consumer in response to a delivered time during which the content was delivered to the content consumer.
